(19) United States
(12) Patent Application Publication
(10) Pub. No.: US 2006/0051529 A1
(43) Pub. Date: Mar. 9, 2006

(54) Recording paper and method for recording image using the same

(75) Inventors: Takashi Ogino, Kanagawa (JP); Kiyoshi Hosoi, Kanagawa (JP); Chizuru Koga, Kanagawa (JP); Tsukasa Matsuda, Kanagawa (JP)

Correspondence Address: MORGAN LEWIS & BOCKIUS LLP, 1111 PENNSYLVANIA AVENUE NW, WASHINGTON, DC, 20004, US

(73) Assignee: FUJI XEROX CO., LTD.

(21) Appl. No.: 11/072,541

(22) Filed: Mar. 7, 2005

(30) Foreign Application Priority Data
Sep. 9, 2004 (JP) 2004-262302

(51) Int. Cl. B41M 5/00

(52) U.S. Cl. 428/32.21

(57) ABSTRACT

A recording paper comprising: a plain paper conataining at least pulp as a raw material; and an organic acid having three or more carboxyl groups in a molecule, wherein the degree of CD shrinkage (%) of the paper is about 0.25 to about 0.65%.

### CROSS-REFERENCE TO RELATED APPLICATION

This application claims priority under 35 USC 119 from Japanese Patent Application No. 2004-262302, the disclosure of which is incorporated by reference herein.

### BACKGROUND OF THE INVENTION

1. Field of the Invention

The present invention relates to a recording paper used for an electrophotographic recording system and an ink jet recording system or the like, and an electrophotographic recording method using the recording paper, and an ink jet record method.

2. Description of the Related Art

Conventionally, after an image to be recorded on paper has been fixed by using an electrophotographic system copying machine, a printer or the like, the paper curls, and problems such as paper jamming when copying or poor storage properties such as an error in stitching with a post-processing apparatus may occur. Particularly, the mechanism of a device and the path taken by paper therein have become complicated due to multi-functionalization such as miniaturization, automatic duplex copying in copying machines and printers, and automatic bookbinding of recent date. Also, the diameter of thermal fusing rolls has become smaller, and the rolls have become more complex. Thus according to the conventional art, there is a large degree of curl after thermal fixing of paper, with the end of a sheet of paper coming into contact with components in a machine, resulting in the occurrence of paper jamming or the like.

The ink jet recording system has been noted since a color ink jet recording system can be achieved relatively easily, consumes little energy and has a low level of noise when recording, and allows the manufacturing cost of the printer to be reduced. In this technology, in recent years, high image quality, high speed printing, and high-reliability have been promoted. Recording is often carried out on plain paper, and therefore it is extremely important to improve the recording aptitude to plain paper. In a conventional ink jet printer, in order to improve black character image quality and reduce loss of color-edge definition due to color mixing, black ink contains ink which contains a pigment as a colorant and has slower permeability into the paper. Color ink contains ink which contains a dye as a colorant and has a faster permeability into the paper. Therefore, when color ink having a high permeability into the paper is used, and an image with a high recording density is printed, there is a large amount of curl and waviness immediately after printing, and paper jamming and rubbing of the image area occur in the printer. Further, there is an extreme decrease in print productivity since relaxation time for curl immediately after printing and time for drying of the ink are additionally required for duplex printing. When an image having a high recording density is printed on paper, a problem wherein a large amount of curl is caused after the printed paper has been allowed to stand for drying. Therefore, it is difficult for high quality image to be compatible with a highly reduced level of curling.

Various studies have been conducted in order to reduce paper curl in the electrophotographic recording system in light of the above-described problems. For example, a method for controlling the dryness of a transfer paper with strain based on distortion and stress existing in the paper is proposed (see Japanese Patent Application Laid-pen (JP-A) No. 5-341554). A method for controlling the residual curvature of a transfer paper is proposed in JP-A No. 3-243953. Based on the difference between characteristics of the paper layers of both sides of the transfer paper, the following methods are proposed: a method for controlling the difference in ash components in both surfaces of a transfer paper as disclosed in JP-A Nos. 7-202897 and 7-295280; a method for controlling the difference in the ratio of the expansion and shrinkage of both surfaces of a transfer paper in JP-A No. 3-236062; a method for controlling the difference of orientation ratios of fibers of both surfaces of a transfer paper as disclosed in JP-A No. 6-138688; a method for controlling the difference in paper density of both surfaces of a transfer paper in JP-A No. 58-176641; and, a method for controlling the difference in freenesses of both surfaces of transfer paper in JP-A No. 6-110243.

However, even if only the difference in dimensional change between both sides of a paper is reduced as described in the above techniques, when the paper produced with the above techniques is used under high temperatures, particularly, there is a large amount of paper curl after thermal fusing in a small printer or the like. In a small-size printer or similar device, more heat is applied to the paper from one side of the paper, which results in a larger curling of the paper after thermal fusing. There is then a high tendency for paper jamming to occur due to contact of the end of the paper with components in a machine. Various studies have been conducted in order to reduce curl in an ink jet recording system. Although with the object of achieving a curl reduction effect, formaldehyde resin or the like may be used for suppressing the expansion of paper due to moisture as disclosed in JP-A Nos. 10-046498 and 2002-201597, when the above-described treatment is performed by internally adding the formaldehyde resin, paper fibers are flocked due to the high reactivity of these materials, and the texture of the paper is extremely deteriorated. Even if the resin is used in a surface sizing press treatment, the reaction starts before coating the resin, with the surface sizing solution being thickened and being coagulated. Accordingly, the quantity of curl reduction material which permeates the cellulose in the paper is decreased, and a sufficient curl reduction effect does not take place. An effective means for solving the aforementioned problems has not yet been known.

### SUMMARY OF THE INVENTION

The present invention has been accomplished in view of the problems described above. The present invention provides a recording paper that includes: a plain paper containing at least pulp as a raw material; and an organic acid having three or more carboxyl groups in a molecule, wherein the degree of CD shrinkage (%) of the paper is about 0.25% to about 0.65%.

The present invention provides a recording paper that includes a plain paper containing at least pulp as a raw material and an organic acid having three or more carboxy groups in a molecule, wherein the degree of CD shrinkage of the paper is about 0.25% to about 0.65%, and wherein the organic acid having three or more carboxyl groups in the molecule is one kind or two or more acids selected from the group consisting of citric acid, 1,2,3,4-butanetetracarboxylic acid, 1,2,3 propanetricarboxylic acid, oxydisuccinic acid, disuccinic tartrarate, carboxyethylthiosuccinic acid and carboxymethylthiosuccinic acid.

Further, the present invention provides an electrophotographic image recording method, that includes: uniformly charging the surface of an electrostatic latent image carrier; exposing the surface of the electrostatic latent image carrier with light to form an electrostatic latent image; developing the electrostatic latent image formed on the surface of the electrostatic latent image carrier by using an electrostatic charge image developer to form a toner image; transferring the toner image onto the recording paper; and fixing the toner image on the recording paper, wherein the recording paper includes: a plain paper containing at least pulp as a raw material; and an organic acid having three or more carboxyl groups in the molecule, the degree of CD shrinkage (%) of the paper being about 0.25% to about 0.65%.

The present invention also provides an image recording method for an ink jet recording system using a recording paper, that includes: ejecting droplets of ink onto a recording paper; and recording an image on the surface of the recording paper, wherein the recording paper includes: a plain paper containing at least pulp as a raw material; and an organic acid having three or more carboxyl groups in a molecule, wherein the degree of CD shrinkage (%) of the paper is about 0.25 to about 0.65%.

### BRIEF DESCRIPTION OF THE DRAWINGS

FIG. 1 is an illustrative drawing of the degree of CD shrinkage showing the change cycle of relative humidity.

FIG. 2 is an illustrative drawing of the measurement of curl.

### DETAILED DESCRIPTION OF THE INVENTION

Hereinafter, the present invention categorized into a recording paper and an image recording method will be described in detail.

[Recording Paper]

The recording paper of the present invention comprises: a plain paper containing at least pulp as a raw material; and an organic acid having three or more carboxyl groups in a molecule, wherein the degree of CD shrinkage (%) of the paper is about 0.25% to about 0.65%.

The recording paper of the present invention is a so-called plain paper, and is a paper which is mainly containing plant fibers such as woodpulp as a raw material, in the surface of which is subjected to size press treatment with a surface sizing agent in order to improve surface strength and stiffness or the like of the paper.

The organic acid having three or more carboxyl groups in the molecule used in the invention is preferably an aliphatic organic acid having 6 to 12 carbon atoms. Specific examples of the acid include citric acid, 1,2,3,4-butanetetracarboxylic acid, 1,2,3propanetricarboxylic acid, oxydisuccinic acid, disuccinic tartrarate, carboxyethylthiosuccinic acid and carboxymethylthiosuccinic acid. However, the organic acid is not particularly limited to the specific acids as long as the organic acid has three or more carboxyl groups. Acid anhydrides which can generate these organic acids by heating may be used. Of the organic acids, particularly, citric acid and 1,2,3,4-butanetetracarboxylic acid are preferable from the viewpoint of cost and safety.

Moreover, the amount of addition of the organic acid is preferably about 0.01 g/m² to about 1.00 g/m² in dry weight, and particularly preferably about 0.02 g/m² to about 0.50 g/m². Furthermore, the amount of addition of the organic acid is more preferably about 0.02 g/m² to about 0.25 g/m². However, there is a fear that the addition of the organic acid in an amount of more than 1.00 g/m² causes an increase in the acidity of the paper and accelerate the reduction of the paper strength. When the organic acid is added in an amount of less than 0.01 g/m², the quantity of the organic acid having three or more carboxyl groups becomes insufficient, the curl preventing effect is lower, and it is difficult to prevent occurrence of paper jamming. The organic acid permeates into the paper, and exerts the effect of the present invention by reacting with the pulp in the paper. Therefore, the organic acid contained only in an ink receiving layer is ineffective.

It is preferable that the organic acid having three or more carboxyl groups in the molecule of the present invention has reacted with the pulp in the paper, but a reaction residue may remain therein. As a method of identifying as to whether the reaction of the acid with the pulp has take place, after decomposing the paper with cellulase, and forming a derivative thereof, the reaction product can be analyzed and identified by using a pyrolysis gas chromatography (GC)—mass spectroscope (MS) (CG-MS). The existence of the ester bond may be identified by use of an infrared spectrophotometer (IR), and the IR spectrum of the organic acid may be identified. Alternatively, After extracting the reaction product with cold water or hot water, the reaction product may be isolated and identified by use of a liquid chromatography (LC) or the like.

Conventionally, a number of patents in which an organic acid is contained in paper have been known, and Japanese Patent Application Publication (JP-B) No. 3513352 or the like discloses that an ink jet paper having an ink image receiving coated layer, which is exclusively used for an ink jet recording system contains an organic acid. In the technologies disclosed in these patent publications, the organic acid functions a pH buffer solution, a colloid stabilizer or a coagulant to contribute to improve image quality, but does not act on paper itself, namely, does not exert its action on cellulose in a substrate to prevent dimensional change of paper. When these papers are applied to an electrophotographic recording copying machine or the like, an ink receiving layer has adhesive property at the time of thermal fixing, and winds around a fuser, resulting in .not being of practical use. In Japanese Patent Application Laid-pen (JP-A) No. 11-174719, an organic acid forms a salt with chitosan which is used for dissolving the chitosan, at the time of paper manufacture in order to improve stiffness due to an increase in hydrogen bonds between pulp and chitosan, and the organic acid is used in order to dissolve chitosan in water. However, the organic acid does not contribute to paper form stability, since the chitosan aggregates in the pulp, and it is difficult to make the degree of CD shrinkage (%) of the paper in a range of about 0.25% to about 0.65%. In these patent documents, the organic acids may have not more than three carboxylic acid groups such as glutamic acid and abietic acid, which are different from the present invention, and do not have paper form stabilizing effect.

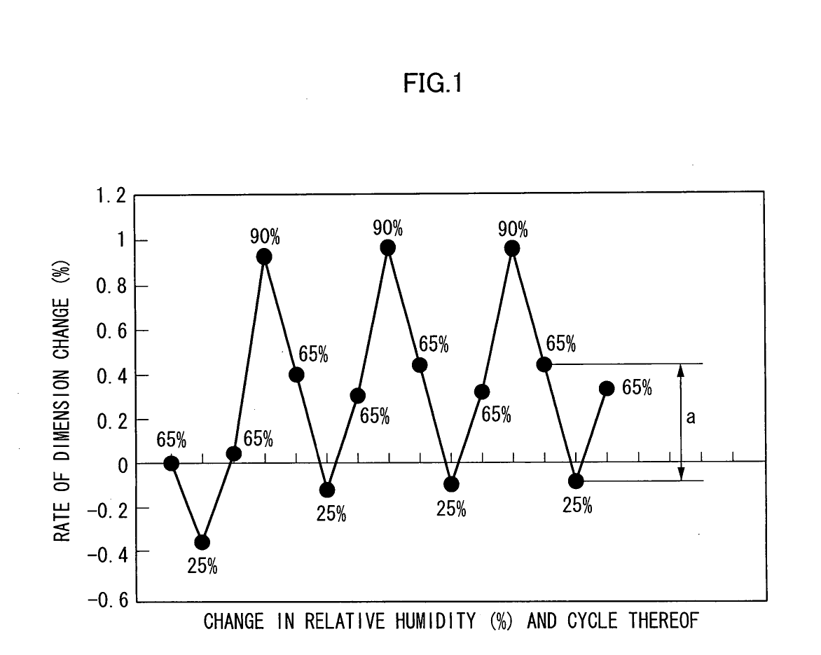

Next, with respect to the “CD shrinkage ratio”, the definition of parameters, a specific measuring method therefor and a method for controlling these values will be explained in detail with reference to FIG. 1. In the present invention, “degree of CD shrinkage” means the dimensional change rate of the recording paper, that is, “a” shown in FIG. 1, when the recording paper is allowed to stand under a constant temperature environmental condition, at 23° C., and the humidity is changed in a cycle of “65% R. H.→25% R. H.→65% R. H.→90% R. H.” repeatedly three times, and the humidity is changed to “65% R. H.→25% R. H.” in the third cycle for moisture absorption/desorption treatment for the paper. The dimensional change of the recording paper is measured by using H-K type expansion and shrinkage level test device manufactured by Oji Engineering Co., Ltd. The “CD (direction)” is a direction perpendicular to the paper manufacturing direction of the recording paper. When the size of the recording paper is measured, the size in the direction perpendicular to the paper manufacturing is measured. The degree of CD shrinkage (%) of the paper is about 0.25% to about 0.65% in the present invention, preferably about 0.30% to about 0.60%, and particularly preferably about 0.30% to about 0.55%. In order to control the degree of CD shrinkage (%) of the paper in a range of about 0.25% to about 0.65%, a method for utilizing the paper form stabilizing effect of the present invention, a method for weakening the beating of the pulp to be used and using a high freeness pulp as a raw materials, a method for using keratinized pulp as a raw materials, a method for using a high basis weight, a method for adding a reinforcing agent for paper drying, a method for thickening the thickness of a paper, a method for optimizing a sizing agent and a filler in a paper, a method for reducing wet press pressure, and a method for reducing fiber orientation.

The recording paper of the present invention is preferably surface-treated with a surface sizing solution containing at least a surface sizing agent, an organic acid having at least three or more carboxyl groups or the acid anhydride. The surface sizing solution is mainly composed of a surface sizing agent and a solvent such as water, and further contains an organic acid in the present invention. The concentration of the surface sizing solution is preferably about 5% to about 15 by mass, and more preferably about 8% to about 12 by mass. The coating quantity of the surface sizing solution after drying coated on one of the surfaces of the recording is preferably about 0.1 g/m² to about 5.0 g/m² on paper, and more preferably about 1.0 g/m² to about 3.0 g/m². When the dry coated quantity is more than 5.0 g/m², the absolute quantity of the surface sizing agent is too large, so that the curl preventing effect is deteriorated, and curl may become large. When the dry coated quantity is less than 0.1 g/m², the absolute quantity of the surface sizing agent is small, and pigment or the like applied together with the surface sizing agent cannot be fixed to the surface of the paper. Accordingly, when the recording paper is conveyed in a copying machine or the like, a large quantity of paper powder is formed in the machine and mechanical troubles may occur in the machine.

Specifically, in the present invention, as the surface sizing agent, not only oxidized starch usually used as a surface sizing agent but also starch such as starch denatured with enzyme, acetylated starch having an improved hydrophobicity and phosphorylated starch may be used. In order to reduce the number of hydrophilic carboxyl groups in view of the hydrophobicity of the surface sizing agent, the starch denatured with an enzyme, the acetylated starch and siliconized starch or the like are more preferable than the oxidized starch used conventionally. Polyvinyl alcohol is preferably used, in which hydrophobic groups are left by reducing a saponification degree extremely, or the crystallinity degree is raised by enhancing the saponification degree extremely to improve the hydrophobicity. Polyvinyl alcohol having a low polymerization degree may be used in order to improve the image quality in the ink jet recording method. Further, a silanol modified surface sizing agent or the like having a high hydrophobicity may be used. These surface sizing agents may be used singly or in combination.

The recording paper of the present invention has preferably a texture index of about 10 to about 50, and more preferably about 15 to about 40. When the texture index is less than 10, the image transfer unevenness in the electrophotographic method tends to occur due to unevenness of texture. When the texture index is 50 or more, it is necessary to strengthen paper beating in order to maintain the homogeneity of the texture, resulting in a large curl of the paper. The term “texture index” as used herein means a value obtained by measurement using a 3D Sheet Analyzer (M/K950) manufactured by M/K Systems, Inc. (MKS Corp.), in which the diaphragm of the analyzer is set to 1.5 mm in diameter, and a microformation tester (MFT). That is, a sample paper is attached onto a rotating drum in the 3D Sheet Analyzer and local differences in the basis weight of the sample paper in terms of difference in light amount by measuring by use of a light source disposed on a drum axis and a photodetector disposed at the outside of the drum corresponding to the light source. The target range of the measurement in this case is set by the diameter of the diaphragm attached to the light incident portion of the photodetector. The differences in light amount (deviations) are then amplified, subjected to an A/D conversion, and classified into 64 optically measured classes of the basis weight. 1,000,000 data are taken per one scanning and histogram frequencies for the data are obtained. The number of the maximum frequencies (peak value) of the histogram is divided by the number of the classes, each having a frequency of 100 or more, selected out of the 64 classes corresponding to the very basis weights. Thereafter, the obtained value is divided by 100. The value obtained in this procedure is defined as the texture index. The greater the texture index is, the better texture is.

In the electrophotographic method, the electrical property of the paper is important. Particularly, in the present invention, a surface-active agent and a cationized material, which can change the electrical property of the paper, are abundantly used, and image transfer unevenness may occur in the electrophotographic method depending on the combination and content of these materials. Therefore, the surface resistivity of at least the surface to be printed of the recording paper in the present invention is in a range of about 1.0×10⁹ to about 1.0×10¹¹ Ω/□, and the above problem can be avoided by setting the volume resistivity of the recording paper to about 1.0×10¹⁰ to about 1.0×10¹² Ω·cm. When the surface resistivity and the volume resistivity are not in the above ranges, respectively, the image transfer unevenness may occur in the electrophotographic method. The surface resistivity of at least the surface to be printed of the recording paper used in the present invention is preferably about 1.0×10⁹ to about 1.0×10¹¹ Ω/□, more preferably about 5.0×10⁹ to about 7.0×10¹⁰ Ω/□, and still more preferably about 5.0×10⁹ to about 2.0×10¹⁰ Ω/□. The surface electric resistivity shows resistance of the surface to which a polyvalent metal salt and/or a cationic resin are/is applied. The volume electric resistivity of the recording paper used in the present invention is preferably in a range of about 1.0×10¹⁰ to about 1.0×10¹² Ω·cm, more preferably in a range of about 1.0×10¹⁰ to about 1.6×10¹¹ Ω·cm, and still more preferably in a range of about 1.3×10¹⁰ to about 4.3×10¹⁰ Ω·cm. The surface resistivity and the volume resistivity are obtained by measuring the recording paper which have been preserved and humidity-conditioned under the conditions of 23° C., 50% RH for 24 hours in accordance with a method based on JIS-K-6911.

The paper of the present invention may be formed of at least cellulose pulp as a raw material. The paper may be the following base paper, and may be a plain paper obtained by applying pigment and a binder or the like onto the surface of the base paper. The base paper contains cellulose pulp, and any known cellulose pulp can be used. Examples thereof include chemical pulps, more specifically, examples of the chemical pulps include bleached hardwwod craft pulp, unbleached hardwood craft pulp, bleached softwood craft pulp, unbleached softwood craft pulp, bleached hardwood craft sulfite pulp, unbleached hardwood craft pulp, unbleached softwood craft sulfite, unbleached softwood craft sulfite pulp, pulp made by chemically treating a fiber material such as wood, cotton, hemp and bast fiber. Further, ground wood pulp obtained by mechanically pulpifying wood or chips, chemi-mechanical pulp obtained by infiltrating a chemical solution into wood or chips and thereafter by mechanically pulpifying the wood and the chips, and thermomechanical pulp obtained by cooking chips until the chips become slightly soft and thereafter, by pulpifying in a refiner can be used. Only virgin pulp may be used for these pulps, and waste paper pulp may be added, if necessary. In particular, when virgin pulp is used, the pulp is preferably bleached by a bleaching method which uses chlorine dioxide without using chlorine gas (Elementally Chlorine Free; ECF), or a method for bleaching by mainly using ozone/hydrogen peroxide or the like without using chlorine compounds (Total Chlorine Free; TCF).

Examples of raw materials of the waste paper pulp include unprinted waste papers formed in bookbinding factories, printing factories and paper cutting factories or the like, which are ultra white, special white, medium white and vitiated white papers formed by cutting, spoilage or cutting-off, high quality waste papers including printed or copied wood free paper or wood free coat papers; waste papers written with aqueous ink, oily ink or a pencil; newsprint waste papers including leaflets which include printed wood free paper, printed wood free coat paper, printed medium quality paper and medium quality coat paper; waste papers including medium quality paper, medium quality coat paper and woody paper. These waste papers may be blended as the raw material for the waste pulp. The waste paper pulp used for the base paper used in the present invention is preferably subjected to at least one of an ozone bleaching treatment or a hydrogen peroxide bleaching treatment. The blending ratio of the waste paper pulp obtained by the bleaching treatment is preferably 50 to 100% to obtain a paper having a higher whiteness. The blending ratio of the waste paper pulp is more preferably about 70% to about 100% in view of recycling resources.

The ozone treatment has the function, which decomposes the fluorescent dye or the like usually included in the wood free paper, and the hydrogen peroxide treatment has the function, which prevents paper from yellowing due to an alkali used in deinking treatment. Specifically, it has been known that not only he deinking from waste paper is facilitated, but also the whiteness of the pulp can be improved by the treatment combining these two treatments. Since this treatment has a function, which decomposes and removes the residual chlorine compound in the pulp, the content of an organic halogen compound is effectively reduced in the waste paper, in which chlorine is used for bleaching.

Filler is preferably added to the paper to adjust opacity, whiteness and surface property of the paper used in the present the invention. Specifically, when the amount of halogen in the paper is desired to be reduced, the filler which does not contain halogen is preferably used. Examples of the filler which can be used include white inorganic pigments such as heavy calcium carbonate, light calcium carbonate, chalk, kaolin, calcined clay, talc, calcium sulfate, barium sulfate, titanium dioxide, zinc oxide, zinc sulfide, zinc carbonate, aluminum silicate, calcium silicate, magnesium silicate, synthetic silica, aluminium hydroxide, alumina, sericite, white carbon, saponite, calcium montmorillonite, sodium montmorillonite and bentonite; organic pigments such as acrylic plastic pigment, polyethylene and urea resin. When the waste paper is blended, ash content contained in the waste paper raw material need to be estimated beforehand, and the addition amount of the pigment need to be adjusted.

An internally-adding sizing agent is preferably added to the base paper of the present invention. A neutral rosin sizing agent, alkenyl succinic anhydride (ASA), alkylketenedimer (AKD), and petroleum resin sizing agent, can be used as the internally-adding sizing agent for acid-free paper. When the surface of the recording paper is adjusted to be cationic for example, a hydrophilic cationic resin or the like can be applied onto the surface as a cationic substance. The degree of sizing of paper before applying the cationic resin onto the paper is preferably about 10 seconds or more and less than about 60 seconds so as to suppress penetration of the cationic resin into the inside of the paper.

The recording paper of the invention is obtained by applying the surface sizing solution to the paper described above. The surface treatment can be performed by applying the surface sizing solution to the paper using an applying means usually used such as a size press, a shim size, a gate roll, a roll coater, a bar coater, an air knife coater, a rod blade coater and a blade coater. Thereafter, the recording paper of the present invention can be obtained through a drying process. Although the basis weight of the recording paper of the present invention is not particularly limited, the basis weight is preferably about 60 to about 128 g/m², more preferably about 60 to about 100 g/m², and still more preferably about 60 to about 90 g/m². The recording paper having a higher basis weight is more advantageous for preventing curling and waviness of the paper. However, when the basis weight is 128 g/m² or more, the stiffness of the paper is too high, and the paper conveying performance in the printer may be deteriorated. When the basis weight is less than 60 g/m², it may be difficult to suppress the curling and waviness, and it is not preferable from the viewpoint of preventing the occurrence of strike through.

The ratio of orientation of fibers is controlled to about 1 to about 1.55 at the time of paper making, preferably about 1.00 to about 1.40, and more preferably about 1.05 to about 1.35. Thus, the curl of the paper (recording paper) after printed by use of the ink jet recording method can be reduced by controlling the ratio of orientation of fibers. The above ratio of orientation of fibers is the ratio of orientation of fibers obtained by an ultrasonic sound wave propagation velocity method, and is a value obtained by dividing the ultrasonic soundwave propagation velocity of the MD direction of the paper (paper conveying direction in a paper machine) by the ultrasonicsound wave propagation velocity of the CD direction of the paper (the perpendicular to the paper conveying direction in the paper machine), and the ratio of orientation of fibers is represented by the following equation.

Ratio of orientation of fibers of base paper obtained by an ultrasonic sound wave propagation velocity method, (T/Y ratio)=ultrasonic sound wave propagation velocity of the MD direction of the paper/ultrasonic sound wave propagation velocity of the CD direction of the paper.

The ratio of orientation of fibers obtained by an ultrasonic sound wave propagation velocity method is measured by using SonicSheetTester (trade name, manufactured by Nomura Trading Company).

It is preferable that the surface of the recording paper of the present invention contains a cationic polymer and a polyvalent metal salt. When the recording paper contains a cationic polymer and a polyvalent metal salt, and the ink for ink jet recording ink contains an anionic polymer, the cationic polymer or the metal salt enables extremely fast coalescence of colorant by crosslinking the anionic polymer, and an excellent print image quality can be obtained. In addition, since the infiltration of the ink solvent into the paper is suppressed, the curl and waviness generated immediately after printing, and the generation of the curl and waviness after the printed paper is allowed to stand for drying can be further improved.

As the polyvalent metal sals, chloride, sulfate, nitrate, formate, acetate or the like of barium, calcium, magnesium, zinc, tin, manganese, aluminum and the other polyvalent metals can be used as the polyvalent metal salt. Specific examples include barium chloride, calcium chloride, calcium acetate, calcium nitrate, calcium formate, magnesium chloride, magnesium sulfate, magnesium nitrate, magnesium acetate, magnesium formate, zinc chloride, zinc sulfate, zinc nitrate, zinc formate, tin chloride, tin nitrate, manganese chloride, manganese sulfate, manganese nitrate, manganese formate, aluminium sulfate, aluminium nitrate, aluminium chloride, aluminium acetate. These polyvalent metal salts may be used singly or in combination. Of the polyvalent metal salts, metal salts having a high solubility in water and a high valence are preferable. When the counter ion of the polyvalent metal salt is a strong acid, the yellow discoloration of the paper after applying the polyvalent metal salts to the paper occurs. Accordingly, the polyvalent metal salts are preferably calcium chloride, calcium formate, magnesium chloride, magnesium formate and the like. Although examples of the cationic polymers include cationized cellulose, cationized starch, cationized starch, the cationic polymers of the present invention are not limited thereto.

The cationic polymer and polyvalent metal salt listed above can be mixed with the surface sizing solution, and resultant solution is coated on the surface of the recording paper. Alternatively, a solution separately prepared by using the cationic polymer and the polyvalent metal salt is coated on the surface of the paper. In the latter case, the coating solution prepared by dissolving the cationic polymer and the polyvalent metal salt in water may be directly coated onto the recording paper (or the paper), but the coating solution is generally used mixing with a binder. The content of the cationic polymer and the polyvalent metal salt in the surface of the recording paper is preferably in a range of about 0.1 to about 2.0 g/m², and more preferably about 0.5 to about 1.0 g/m². When the content of the cationic polymer and the polyvalent metal salt is less than 0.1 g/m² the reaction between the cationic polymer or the polyvalent metal salt and the pigment or the anionic polymer in the ink is weakened. As a result, the image quality may be deteriorated, and the curl and waviness of paper immediately after the paper is printed, and the curl and waviness after to the paper is allowed to stand for drying may become larger. When the content of the cationic polymer and the polyvalent metal salt is more than 2.0 g/m², the ink permeability may deteriorate, and the ink dryness may deteriorate in a high-speed printing.

[Electrophotographic Image Recording Method]

An electrophotographic image recording method of the present invention, comprising the steps of: uniformly charging the surface of an electrostatic latent image carrier; exposing the surface of the electrostatic latent image carrier with light to form an electrostatic latent image; developing the electrostatic latent image formed on the surface of the electrostatic latent image carrier with an electrostatic charge image developer to form a toner image; transferring the formed toner image onto a recording paper; and fixing the toner image on the surface of the recording paper, wherein the recording paper is the recording paper of the present invention described above. The method for recording the image of the present invention provides a high quality image as that of the conventional image recording method, and can suppress the curl generated immediately after printing. The image forming device used for the method for recording the image of the electrophotographic method of the present invention is not particularly limited to a specific one as long as the electrophotographic recording device which uses an electrophotographic process having a charging step, an exposing step, a developing step, an image transferring step and a fixing step. For instance, a color image forming device using a development system in which a four cycle developing method is used to form a color toner image by sequentially applying developing agents containing color toners of cyan, magenta, yellow and black toners, respectively, to an electrostatic letent image carrier, or a color image forming device (so-called tandem machine) which is provided with four development units corresponding to four colors, respectively, can be used. The known toners which can be used for forming a color image are not limited to particular toners. For instance, in order to obtain an image having a high definition, the toners which have a spherical shape, a small particle diameter and particle size distribution, and the toners including a binder resin having a low melting point which can be fused at a low temperature for the purpose of achieving energy saving.

(Method for Recording an Image for an Inkjet Recording System)

The ink jet record method of the present invention can provide good print quality, even if any known ink jet devices and ink jet recording system are used. Systems having a heating means for heating a recording paper and the like before and after printing to heat the recording paper and ink at a temperature of about 50° C. to about 200° C., so that absorption and fixing of the ink are promoted can used in the present invention.

Next, an example of an ink jet recording device suitable for performing the ink jet record method in the present invention will be explained. This example is a so-called multipath method, in which the surface of a recording paper is scanned by a recording head plural times to form an image. Examples of a method for ejecting ink from a nozzle include a so-called thermal ink jet method in which the ink in the nozzle is foamed by electrically heating a heater provided in the nozzle, and the ink is thereby ejected by the pressure generated. The other examples include a method in which typically, a piezoelectric element is physically deformed by energizing the piezoelectric element, and ink is ejected from a nozzle by the force produced by the deformation. In the ink jet recording device used in the ink jet recording method of the present invention, a method for ejecting the ink from the nozzle may be any of the above method, and is not limited to these methods.

### EXAMPLES

The present invention will now be specifically described with reference to Examples and Comparative Examples. However, the present invention is not limited thereto.

(Recording Paper 1)

A dry pulp containing a hardwood craft pulp is macerated, and beaten and adjusted so as to make a freeness of 420 ml, and a pulp dispersing solution is prepared so that the pulp in terms of solid is set to 0.3% by mass. 0.3 parts by mass of succinic anhydride (ASA) as an internally adding sizing agent (trade name: Fibran-81 manufactured by NIPPON NSC, Ltd.) and 0.5 parts by mass of cationized starch (trade name: Cato-304 manufactured by NIPPON NSC, Ltd.) relative to 100 parts by mass of the pulp solid contained in the pulp dispersing solution are blended with the pulp dispersing solution. A paper is made under the conditions of the paper making speed of 1000 m/min and a paper material discharge pressure of 1.5 kg/cm² using a 80 mesh wire by an orientational paper machine for experimental use manufactured by KUMAGAI RIKI KOGYO LTD. Thereafter, the wet paper is compressed by a press for a square sheet machine manufactured by KUMAGAI RIKI KOGYO LTD. at 10 kg/cm² for 3 minutes, and is dried under the conditions of 120° C. and 0.5 m/min by a KRK rotary drier manufactured by KUMAGAI RIKI KOGYO LTD., so that a recording paper having a basis weight of 68 g/m² is obtained. A solution (surface sizing solution) having a concentration of 8% by mass containing 10 parts by mass of mirabilite and 3 parts by mass of citric acid (citric acid manufactured by IWATA CHEMICAL CO., LTD.) relative to 100 parts by mass of autoenzyme denatured starch (starch obtained by denaturing cornstarch Y with an alpha-amylase, manufactured by NIPPON SHOKUHINN KAKO CO. LTD.), as surface sizing agents, is heated at 50° C. After the solution is size-pressed by using a size press machine for experimental use manufactured by KUMAGAI RIKI KOGYO LTD. so that the treatment amount for the recording paper is set to 2 g/m² (the adhered amount of the organic acid is 0.06 g/m²), the paper is dried under the conditions of 120° C. and 0.5 m/min by a KRK rotary drier manufactured by KUMAGAI RIKI KOGYO LTD. to obtain a recording paper (1) having a basis weight of 70 g/m².

(Recording Paper 2)

A dry pulp containing a hardwood craft pulp is macerated, and beaten and adjusted so as to make a freeness of 420 ml, and a pulp dispersing solution is prepared so that the pulp in terms of solid is set to 0.3% by mass. 0.3 parts by mass of succinic anhydride (ASA) as an internally adding sizing agent (trade name: Fibran-81 manufactured by NIPPON NSC, Ltd.) and 0.5 parts by mass of cationized starch (trade name: Cato-304 manufactured by NIPPON NSC, Ltd.) relative to 100 parts by mass of the pulp solid contained in the pulp dispersing solution are blended with the pulp dispersing solution. Paper is made under the conditions of the paper making speed of 1000 m/min and paper material discharge pressure of 1.5 kg/cm² using a 80 mesh wire by an orientational paper machine for experimental use manufactured by KUMAGAI RIKI KOGYO LTD. Thereafter, the wet paper is compressed by a press for a square sheet machine manufactured by KUMAGAI RIKI KOGYO LTD. at 10 kg/cm² for 3 minutes, and is dried under the conditions of 120° C. and 0.5 m/min by a KRK rotary drier manufactured by KUMAGAI RIKI KOGYO LTD., so that a recording paper having a basis weight of 68 g/m² is obtained. A solution (surface sizing solution) having a concentration of 8% by mass containing 10 parts by mass of mirabilite and 5 parts by mass of 1,2,3,4-butanetetra carboxylic acid relative to 100 parts by mass of autoenzyme denatured starch (starch obtained by denaturing cornstarch Y with an alpha-amylase, manufactured by NIPPON SHOKUHINN KAKO CO. LTD.), as surface sizing agents, is heated at 50° C. After the solution is size-pressed by using a size press machine for experimental use manufactured by KUMAGAI RIKI KOGYO LTD. so that the treatment amount for the recording paper is set to 2 g/m² (the adhered amount. of the organic acid is 0.09 g/m²), the paper is dried under the conditions of 120° C. and 0.5 ml/min by a KRK rotary drier manufactured by KUMAGAI RIKI KOGYO LTD. to obtain a recording paper (2) having a basis weight of 70 g/m².

(Recording Paper 3)

A recording paper (3) having the same basis weight of 70 g/m² as that of the recording paper 2 is obtained except that a pulp dispersing solution obtained by macerating a dry pulp containing a hardwood craft pulp, beating and adjusting to have a freeness of 420 ml is changed to a pulp dispersing solution obtained by using 3 parts by mass of a dry pulp containing hardwood craft pulp relative to 7 parts by mass of medium-grade waste paper, beating and adjusting to have a freeness of 350 ml.

(Recording Paper 4)

A recording paper (4) having the same basis weight of 70 g/m² as that of the recording paper 2 is obtained except that 1,2,3,4-butanetetracarboxylic acid as an the organic acid in the recording paper (1) is changed to 1,2,3-propanetricarboxylic acid.

(Recording Paper 5)

A recording paper (5) having the same basis weight of 70 g/m² as that of the recording paper 2 is obtained except that 1,2,3,4butanetetracarboxylic acid as an the organic acid in the recording paper 2 is changed to oxydisuccinic acid.

(Recording Paper 6)

A recording paper (6) having the same basis weight of 70 g/m² as that of the recording paper 2 is obtained except that 1,2,3,4-butanetetracarboxylic acid as an organic acid in the recording paper 2 is changed to disuccinic tartrarate.

(Recording Paper 7)

A recording paper (7) having the same basis weight of 70 g/m² as that of the recording paper (1) is obtained except that the autoenzyme denatured starch as a surface sizing agent of the recording paper (1) is changed to an oxidized starch (Ace A: manufactured by OJI CORNSTARCH CO., LTD.).

(Recording Paper 8)

A dry pulp containing a hardwood craft pulp is macerated, and beaten and adjusted so as to make a freeness of 420 ml, and a pulp dispersing solution is prepared so that the pulp in terms of solid is set to 0.3% by mass. 0.3 parts by mass of succinic anhydride (ASA) as an internally adding sizing agent (trade name: Fibran-81 manufactured by NIPPON NSC, Ltd.) and 0.5 parts by mass of cationized starch (trade name: Cato-304 manufactured by NIPPON NSC, Ltd.), and 3 Parts by mass of citric acid (applied amount of citric acid is 0.06 g/m²) relative to 100 parts by mass of the pulp solid contained in the pulp dispersing solution are blended with the pulp dispersing solution. Paper is made under the conditions of the paper making speed of 1,000 m/min and a paper material discharge pressure of 1.5 kg/cm² using a 80 mesh wire by an orientational paper machine for experimental use manufactured by KUMAGAI RIKI KOGYO LTD. Thereafter, the wet paper is compressed by a press for a square sheet machine manufactured by KUMAGAI RIKI KOGYO LTD. at 10 kg/cm² for 3 minutes, and is dried under the conditions of 120° C. and 0.5 m/min by a KRK rotary drier manufactured by KUMAGAI RIKI KOGYO LTD., so that a recording paper having a basis weight of 68 g/m² is obtained. A solution (surface sizing solution) having a concentration of 8% by mass containing 10 parts by mass of mirabilite relative to 100 parts by mass of autoenzyme denatured starch (starch obtained by denaturing cornstarch Y with an alpha-amylase, manufactured by NIPPON SHOKUHINN KAKO CO. LTD.), as surface sizing agents, is heated at 50° C. After the solution is size-pressed by using a size press machine for experimental use manufactured by KUMAGAI RIKI KOGYO LTD. so that the treatment amount for the recording paper is set to 2 g/m² (the adhered amount. of the organic acid is 0.09 g/m²), the paper is dried under the conditions of 120° C. and 0.5 m/min by a KRK rotary drier manufactured by KUMAGAI RIKI KOGYO LTD. to obtain a recording paper (2) having a basis weight of 70 g/m².

(Recording Paper 9)

A recording paper (9) having the same basis weight of 70 g/m² as that of the recording paper (1) is obtained except that 3 parts by mass of citric acid (citric acid manufactured by IWATA CHEMICAL) relative to 100 parts by mass of the autoenzyme denatured starch (manufactured by NIHON SHOKUHIN KAKO CO., LTD., starch obtained by denaturing cornstarch Y by alpha-amylase) as a surface sizing agent is changed to that of 50 parts by mass of the citric acid.

(Recording Paper 10)

A recording paper (9) having the same basis weight of 70 g/m² as that of the recording paper (1) is obtained except that 3 parts by mass of citric acid (citric acid manufactured by IWATA CHEMICAL) relative to 100 parts by mass of the autoenzyme denatured starch (manufactured by NIHON SHOKUHIN KAKO CO., LTD., starch obtained by denaturing cornstarch Y by alpha-amylase) as a surface sizing agent is changed to that of 0.5 parts by mass of the citric acid.

(Recording Paper 11)

A recording paper (11) having the same basis weight of 70 g/m² as that of the recording paper (1) is obtained except that citric acid as an organic acid in the recording paper (1) is changed to glutamic acid.

(Recording Paper 12)

A recording paper (12) having the same basis weight of 70 g/m² as that of the recording paper (1) is obtained except that citric acid as an organic acid in the recording paper (1) is changed to ascorbic acid.

(Recording Paper 13)

A recording paper (13) having the same basis weight of 70 g/m² as that of the recording paper (1) is obtained except that citric acid as an organic acid in the recording paper (1) is changed to acetic acid.

(Recording Paper 14)

A recording paper (14) having the same basis weight of 70 g/m² as that of the recording paper (1) is obtained except that citric acid as an organic acid in the recording paper (1) is changed to fumaric acid.

(Recording Paper 15)

A recording paper (15) having the same basis weight of 70 g/m² as that of the recording paper (1) is obtained except that citric acid as an organic acid in the recording paper (1) is changed to glyoxal as a shape-stabilizing agent.

(Recording Paper 16)

A recording paper (16) having the same basis weight of 70 g/m² as that of the recording paper (1) is obtained except that citric acid as an organic acid in the recording paper (8) is changed to glyoxal as a shape-stabilizing agent.

(Recording Paper 17)

A recording paper (17) having the same basis weight of 70 g/m² as that of the recording paper (1) is obtained except that citric acid as an organic acid in the recording paper (1) is changed to an epichlorohydrin resin as a shape-stabilizing agent.

Examples and Comparative Examples are collectively shown in Tables 1A, 1B.

Evaluation Method

(1) Curl Evaluation in Electrophotographic Recording System

The papers produced by the above method are conditioned under the conditions of 23° C. and 50% RH for 12 hours or more. A felt side surface (the opposite surface of a dehydrating surface during paper making) of the paper is made to a print surface of the paper. Single-side copying process without an image is effected by using DocuPrint 260 manufactured by Fuji Xerox Printing Systems, and the following evaluation is performed.

A printer output is performed without printing an image on the paper cut in B5 size so that the MD direction (the paper making direction of the paper) is set to a longitudinal direction, and the paper conveying performance is estimated by the following evaluation criteria.

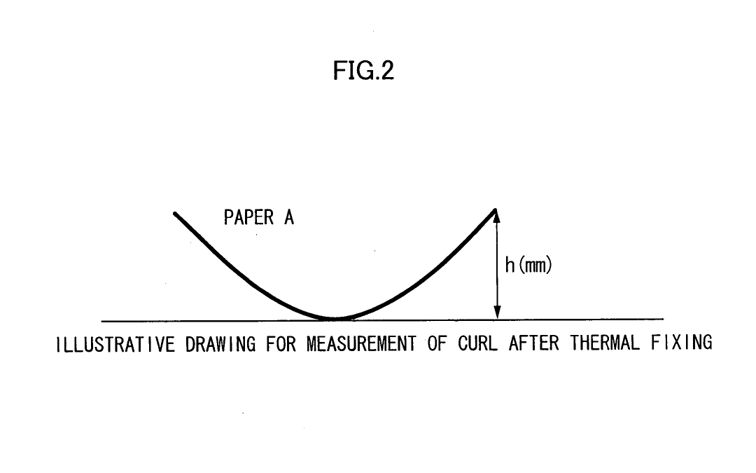

FIG. 2 is an illustrative drawing for the measurement of curl after thermal fixing, and h shows the curl height of a paper A after thermal fixing. A and B are acceptable levels.
A: h<45 mm
B: 45 mm≦h<55 mm
C: h≧55 mm
   (2) Evaluation of Transfer Property in Electrophotographic Recording System

The paper produced by the above method is conditioned under the conditions of 23° C. and 50% RH for 12 hours or more. A felt side surface (the opposite surface of a dehydrating surface during paper making) of the paper is made to a print surface of the paper. A chart is used, which can output a monochromatic black image in which a dot percentage is 100%. A printer output is performed by using DocuPrint 3530 manufactured by Fuji Xerox Printing Systems, and uneven transfer is visually evaluated by the following evaluation criteria. A is an acceptable level.
A: No toner transfer unevenness and extremely excellent. No problem in practical use.
B: Toner transfer unevenness and slightly inferior. Problematic in practical use.
C: Large toner transfer unevenness and inferior. Problematic in practical use.
   (3) Evaluation of Curl in Ink Jet Recording System
   Evaluation of Curl Immediately after Printing

The margin of 5 mm is set in a postcard sized recording paper, and the 100% solid magenta image is printed. An amount of the hanging curl formed at the surface opposite to the printed surface is measured immediately after printing. The measured values are converted into the curvature, and are evaluated. The evaluation criteria are as follows, wherein A and B are acceptable levels.
A: Less than 35 m⁻¹, B: 35 m⁻¹ or more and Less than 50 m⁻¹, C: 50 m⁻¹ or more
   Evaluation of Curl after the Paper is Allowed to Stand for Drying

The margin of 5 mm is set on a postcard size recording paper, and the 100% solid magenta image is printed. The printed surface is placed horizontally and conditioned the paper which is allowed to stand under the conditions at 23° C. and 50% RH, and the generating amount of the hanging curl generated after the paper is allowed to stand for 100 hours after printing is measured. The measured values are converted into the curl curvature, and are evaluated. The evaluation criteria are as follows, wherein A and B are acceptable levels.
A: Less than 30 m⁻¹, B: 30 m⁻¹ or more and less than 75 m⁻¹, C: 75 m⁻¹ or more
   (4) pH Value of Paper Surface

The papers produced by the above method are conditioned under the conditions at 23° C., 50% RH for 12 hours or more, and is measured by the method for measuring pH of paper surface according to JAPAN-TAPPI No. 49-2. The evaluation criteria are as follows, and A and B are acceptable levels.
A: pH≧6.5
B: 6.0≦pH<6.5

C: pH<6.0

TABLE 1A
Composition of Recording Paper

| | | | Quantity of | | |
|---|---|---|---|---|---|
| | | | surface | Shape-stabilizing agent | |
| | | | sizing agent | | Conventional |
| | | | being | | shape- |
| Production | | Composition of surface | applied | Name of organic acid | stabilizing |
| No. | Pulp used | sizing agent | (g/cm²) | substance | agent |
| Recording | Freeness of | Autoenzyme denatured | 20 | Citric acid | — |
| paper (1) | hardwood | starch/Mirabilite/ | | | |
| | pulp 420 ml | organic acid = 100:10:3 | | | |
| Recording | Freeness of | Autoenzyme denatured | 20 | Butanetetracarboxylic | — |
| paper (2) | hardwood | starch/Mirabilite/ | | acid | |
| | pulp 420 ml | organic acid = 100:10:5 | | | |
| Recording | Medium-grade | Autoenzyme denatured | 20 | Butanetetracarboxylic | — |
| paper (3) | used paper: | starch/Mirabilite/ | | acid | |
| | hardwood | organic acid = 100:10:5 | | | |
| | pulp = 7:3 | | | | |
| | blend | | | | |
| | Freeness 350 | | | | |
| | ml | | | | |
| Recording | Freeness of | Autoenzyme denatured | 20 | Propanetricarboxylic | — |
| paper (4) | hardwood | starch/Mirabilite/ | | acid | |
| | pulp 420 ml | organic acid = 100:10:5 | | | |
| Recording | Freeness of | Autoenzyme denatured | 20 | Oxydisuccinic acid | — |
| paper (5) | hardwood | starch/Mirabilite/ | | | |
| | pulp 420 ml | organic acid = 100:10:5 | | | |
| Recording | Freeness of | Autoenzyme denatured | 20 | Disuccinic tartrarate | — |
| paper (6) | hardwood | starch/Mirabilite/ | | | |
| | pulp 420 ml | organic acid = 100:10:5 | | | |
| Recording | Freeness of | Oxidized starch (Ace A)/ | 20 | Citric acid | — |
| paper (7) | hardwood | Mirabilite/organic | | | |
| | pulp 420 ml | acid = 100:10:3 | | | |
| Recording | Freeness of | Autoenzyme denatured | 20 | Citric acid | — |
| paper (8) | hardwood | starch/ | | | |
| | pulp 420 ml + | Mirabilite = 100:10 | | | |
| | internal citric | | | | |
| | acid | | | | |
| Recording | Freeness of | Autoenzyme denatured | 20 | Citric acid | — |
| paper(9) | hardwood | starch/Mirabilite/ | | | |
| | pulp 420 ml | organic acid = 100:10:50 | | | |
| Recording | Freeness of | Autoenzyme denatured | 20 | Citric acid | — |
| paper (10) | hardwood | starch/Mirabilite/ | | | |
| | pulp 420 ml | organic acid = 100:10:0.5 | | | |
| Recording | Freeness of | Autoenzyme denatured | 20 | Glutamic acid | — |
| paper (11) | hardwood | starch/Mirabilite/ | | | |
| | pulp 420 ml | organic acid = 100:10:3 | | | |
| Recording | Freeness of | Autoenzyme denatured | 20 | Ascorbic acid | — |
| paper (12) | hardwood | starch/Mirabilite/ | | | |
| | pulp 420 ml | organic acid = 100:10:3 | | | |
| Recording | Freeness of | Autoenzyme denatured | 20 | Citric acid + | — |
| paper (13) | hardwood | starch/Mirabilite/ | | chitosan | |
| | pulp 420 ml | organic acid = 100:10:3 | | | |
| Recording | Freeness of | Autoenzyme denatured | 20 | Fumaric acid | — |
| paper (14) | hardwood | starch/Mirabilite/ | | | |
| | pulp 420 ml | organic acid = 100:10:3 | | | |
| Recording | Freeness of | Self-enzyme modified | 20 | — | Glyoxal |
| paper (15) | hardwood | starch/Mirabilite/ | | | |
| | pulp 420 ml | crosslinking agent = | | | |
| | | 100:10:3 | | | |
| Recording | Freeness of | Autoenzyme denatured | 20 | — | Glyoxal |
| paper (16) | hardwood | starch/Mirabilite = | | | |
| | pulp 420 ml + | 100:10 | | | |
| | internal | | | | |
| | glyoxal | | | | |
| Recording | Freeness of | Self-enzyme modified | 20 | — | Epichloro- |
| paper (17) | hardwood | starch/Mirabilite/ | | | hydrin resin |
| | pulp 420 ml | organic acid = 100:10:3 | | | |

| | |
|---|---|
| Composition of Recording Paper | Characteristic value of recording paper |

| | Shape-stabilizing agent | | | | | Surface electric |
|---|---|---|---|---|---|---|
| | Number of | | Fine | Expansion | Formation | resistivity/ |
| Production | carboxylic | Content | basis | and | index | volume electric |
| No. | acid | (g/m²) | weight | shrinkage | coefficient | resistivity value |
| Recording | 3 | 0.060 | 70 | 0.5 | 25 | 1.0 × 10¹⁰/1.0 × 10¹¹ |
| paper (1) | | | | | | |
| Recording | 4 | 0.090 | 70 | 0.55 | 25 | 1.0 × 10¹⁰/1.0 × 10¹¹ |
| paper (2) | | | | | | |
| Recording | 4 | 0.090 | 70 | 0.55 | 25 | 1.0 × 10¹⁰/1.0 × 10¹¹ |
| paper (3) | | | | | | |
| Recording | 3 | 0.090 | 70 | 0.55 | 25 | 1.0 × 10¹⁰/1.0 × 10¹¹ |
| paper (4) | | | | | | |
| Recording | 4 | 0.090 | 70 | 0.55 | 25 | 1.0 × 10¹⁰/1.0 × 10¹¹ |
| paper (5) | | | | | | |
| Recording | 6 | 0.090 | 70 | 0.55 | 25 | 1.0 × 10¹⁰/1.0 × 10¹¹ |
| paper (6) | | | | | | |
| Recording | 3 | 0.060 | 70 | 0.6 | 25 | 1.0 × 10¹⁰/1.0 × 10¹¹ |
| paper (7) | | | | | | |
| Recording | 3 | 0.060 | 70 | 0.6 | 20 | 1.0 × 10¹⁰/1.0 × 10¹¹ |
| paper (8) | | | | | | |
| Recording | 3 | 0.630 | 70 | 0.48 | 25 | 1.0 × 10¹⁰/1.0 × 10¹¹ |
| paper(9) | | | | | | |
| Recording | 3 | 0.009 | 70 | 0.68 | 25 | 1.0 × 10¹⁰/1.0 × 10¹¹ |
| paper (10) | | | | | | |
| Recording | 1 | 0.060 | 70 | 0.68 | 25 | 1.0 × 10¹⁰/1.0 × 10¹¹ |
| paper (11) | | | | | | |
| Recording | 1 | 0.060 | 70 | 0.68 | 25 | 1.0 × 10¹⁰/1.0 × 10¹¹ |
| paper (12) | | | | | | |
| Recording | 1 | 0.600 | 70 | 0.71 | 10 | 1.0 × 10¹⁰/1.0 × 10¹¹ |
| paper (13) | | | | | | |
| Recording | 2 | 0.060 | 70 | 0.68 | 25 | 1.0 × 10¹⁰/1.0 × 10¹¹ |
| paper (14) | | | | | | |
| Recording | — | 0.060 | 70 | 0.66 | 23 | 1.0 × 10¹⁰/1.0 × 10¹² |
| paper (15) | | | | | | |
| Recording | — | 0.060 | 70 | 0.66 | 8 | 1.0 × 10¹⁰/1.0 × 10¹² |
| paper (16) | | | | | | |
| Recording | — | 0.060 | 70 | 0.66 | 23 | 1.0 × 10¹⁰/1.0 × 10¹² |
| paper (17) | | | | | | |

TABLE 2A

| | | Evaluation result | | | | |
|---|---|---|---|---|---|---|
| | | Electrophotographic recording method | | Ink jet record method | | |
| Example/Comparative | Recording | Height of | Transfer property | Curl immediately | Curl after | pH of paper |
| Example number | paper | curl | evaluation | after printing | leaving to dry | surface |
| Example 1 | Recording | A | A | A | A | A |
| | paper (1) | | | | | |
| Example 2 | Recording | A | A | A | A | A |
| | paper (2) | | | | | |
| Example 3 | Recording | A | A | A | A | A |
| | paper (3) | | | | | |
| Example 4 | Recording | A | A | A | A | A |
| | paper (4) | | | | | |
| Example 5 | Recording | A | A | A | A | A |
| | paper (5) | | | | | |
| Example 6 | Recording | A | A | A | A | A |
| | paper (6) | | | | | |
| Example 7 | Recording | B | A | B | B | A |
| | paper (7) | | | | | |
| Example 8 | Recording | A | A | A | A | A |
| | paper (8) | | | | | |
| Example 9 | Recording | A | A | A | A | B |
| | paper (9) | | | | | |
| Comparative Example 1 | Recording | C | A | C | C | A |
| | paper (11) | | | | | |
| Comparative Example 2 | Recording | C | A | C | C | A |
| | paper (12) | | | | | |
| Comparative Example 3 | Recording | C | A | C | C | A |
| | paper (13) | | | | | |
| Comparative Example 4 | Recording | C | A | C | C | A |
| | paper (14) | | | | | |
| Comparative Example 5 | Recording | C | A | C | C | A |
| | paper (15) | | | | | |
| Comparative Example 6 | Recording | B | C | B | B | A |
| | paper (16) | | | | | |
| Comparative Example 7 | Recording | B | C | B | B | A |
| | paper (17) | | | | | |
| Comparative Example 8 | Recording | B | C | B | B | A |
| | paper (18) | | | | | |

The invention can provide a recording paper which has small curl and in which the paper jamming is drastically reduced even when the recording paper is used in a copying machine and a printer for an electrophotographic recording/ink jet recording system, particularly when the copying machine and printer are miniaturized and multi-functionalized. Particularly, the invention can improve the travel reliability of the conveyance of the transfer paper for the electrophotographic system in which one surface of the transfer paper in more susceptible to heat from a fixing mechanism of the copying machine or under a condition of a high temperature. When the recording paper is used for the ink jet recording system, the dimensional change of the can be reduced and the paper jamming can be greatly reduced at the time of a duplex copying and print. The present invention can provide a recording paper and a recording method using the paper which can stably conveyed by suppressing the curl at the time of printing and can use the ink jet and the electrophotography method. That is, the recording paper of the invention can be output without paper jamming in the output machine since the recording paper has small curl. Further, since the viscosity of the size pressing solution is not increased, flock is not easily take place, even if the sizing agent is used internally. Since the coating unevenness of the surface sizing agent and the texture unevenness at the time of paper making can be reduced, the transfer unevenness in the secondary transfer of the toner can be reduced, and troubles associated therewith can be prevented.

What is claimed is:

1. A recording paper which is a plain paper made from at least pulp comprising:
an organic acid having three or more carboxyl groups in a molecule, wherein a CD shrinkage rate (%) of the recording paper is from about 0.25 to about 0.65%.

2. A recording paper according to claim 1, wherein the recording paper has a texture index of from about 10 to about 50.

3. A recording paper according to claim 1, wherein a surface resistivity of a surface to be printed of the recording paper is from about 1.0×10⁹ to about 1.0×10¹¹ Ω/□.

4. A recording paper according to claim 1, wherein a volume resistivity of a surface to be printed of the recording paper is from about 1.0×10¹⁰ to about 1.0×10¹² Ω·cm.

5. A recording paper according to claim 1, wherein the recording paper has a ratio of fiber orientation of from about 1.00 to about 1.55.

6. A recording paper according to claim 1, wherein an amount of the organic acid in the recording paper is from about 0.01 g/m² to about 1.00 g/m² in dry weight, the organic acid having three or more carboxyl group in the molecule.

7. A recording paper according to claim 1, wherein the amount of the organic acid hav in the recording paper is from about 0.02 g/m² to about 0.50 g/m² in dry weight, the organic acid having three or more carboxyl groups in the molecule.

8. A recording paper according to claim 1, wherein the organic acid having three or more carboxyl groups in the molecule is selected from citric acid, 1,2,3,4-butanetetracarboxylic acid, 1,2,3-propanetricarboxylic acid, oxydisuccinic acid, disuccinic tartrarate, carboxyethylthiosuccinic acid and carboxymethylthiosuccinic acid.

9. A recording paper according to claim 8, wherein the recording paper has the texture index of from about 10 to about 50.

10. A recording paper according to claim 8, wherein the surface resistivity of the surface to be printed of the recording paper is from about 1.0×10⁹ to about 1.0×10¹¹ Ω/□.

11. A recording paper according to claim 8, wherein the volume resistivity of the surface to be printed of the recording paper is from about 1.0×10¹⁰ to about 1.0×10¹² Ω·cm.

12. A recording paper according to claim 8, wherein the recording paper has the ratio of fiber orientation of from about 1.00 to about 1.55.

13. A recording paper according to claim 8, wherein the amount of the organic acid in the recording paper is from about 0.01 g/m² to about 1.00 g/m² in dry weight, the organic acid having three or more carboxyl groups in the molecule.

14. A recording paper according to claim 8, wherein the amount of the organic acid in the recording paper is from about 0.02 g/m² to about 0.50 g/m² in dry weight, the organic acid having three or more carboxyl groups in the molecule.

15. An electrophotographic image recording method comprising:
uniformly charging a surface of an electrostatic latent image carrier;
exposing the surface of the electrostatic latent image carrier with a light to form an electrostatic latent image;
developing the electrostatic latent image formed on the surface of the electrostatic latent image carrier by using a static charge image developer to form a toner image;
transferring the toner image onto a recording paper; and
fixing the toner image on the recording paper, wherein the recording paper which is a plain paper made from at least pulp comprising:
an organic acid having three or more carboxyl groups in a molecule, and having a CD shrinkage rate (%) of from about 0.25 to about 0.65%.

16. An electrophotographic image recording comprising:
uniformly charging the surface of an electrostatic latent image carrier;
exposing the surface of the electrostatic latent image carrier with the light to form an electrostatic latent image;
developing the electrostatic latent image formed on the surface of the electrostatic latent image carrier by using a static charge image developer to form a toner image;
transferring the toner image onto the recording paper; and
fixing the toner image on the recording paper,
wherein the recording paper which is a plain paper made from at least pulp comprising:
an organic acid having three or more carboxyl groups in a molecule, and having a CD shrinkage rate (%) of the recording paper of from about 0.25 to about 0.65%,
and having a texture index of from about 10 to about 50.

17. An image recording method for an ink jet recording comprising:
ejecting droplets of ink onto the recording paper; and
recording an image on the surface of the recording paper,
wherein the recording paper which is a plain paper made from at least pulp comprising:
an organic acid having three or more carboxyl groups in a molecule,
and having a CD shrinkage rate (%) of the recording paper of from about 0.25 to about 0.65%.

18. An image recording method for an ink jet recording comprising:
ejecting droplets of ink onto the recording paper; and
recording an image on the surface of the recording paper,
wherein the recording paper which is a plain paper made from at least pulp comprising:
an organic acid having three or more carboxyl groups in a molecule, and having a CD shrinkage rate (%) of the recording paper of from about 0.25 to about 0.65%,
and having a texture index of from about 10 to about 50.
